(19) United States
(12) Patent Application Publication
(10) Pub. No.: US 2024/0097295 A1
(43) Pub. Date: Mar. 21, 2024

(54) Energy Storage System and Motor Vehicle

(71) Applicant: Bayerische Motoren Werke Aktiengesellschaft, Muenchen (DE)

(72) Inventors: Azad DARBANDI, Fraunberg (DE); Tobias SCHMIEG, Niederstetten (DE)

(21) Appl. No.: 18/273,301

(22) PCT Filed: Jan. 17, 2022
(86) PCT No.: PCT/EP2022/050875

§ 371 Date: Jul. 20, 2023

(30) Foreign Application Priority Data
Jan. 21, 2021 (DE) 10 2021 101 234.1

(51) Int. Cl. H01M 50/588; H01M 10/653; H01M 10/658; H01M 50/209; H01M 50/213; H01M 50/24; H01M 50/276; H01M 50/278; H01M 50/282; H01M 50/342; H01M 50/59

(52) U.S. Cl. CPC H01M 50/588; H01M 10/653; H01M 10/658; H01M 50/209; H01M 50/213; H01M 50/24; H01M 50/276; H01M 50/278; H01M 50/282; H01M 50/3425; H01M 50/59; H01M 2200/20; H01M 2220/20

(57) ABSTRACT

An energy storage system for storing electrical energy is provided. The energy storage system includes one or more energy storage cells, one or more supports and one or more protective films that are interposed between the one or more energy storage cells and the one or more supports. A motor vehicle having such an energy storage system is also provided.

### BACKGROUND AND SUMMARY OF THE INVENTION

The invention relates to an energy storage unit and to a motor vehicle having such an energy storage unit.

Energy storage units typically have multiple energy storage cells, and such energy storage cells can be designed, for example, for electrochemical storage of energy.

It is a preferred object of the technology/invention disclosed here to reduce or remedy at least one disadvantage of a previously known solution or to suggest an alternative solution. In particular, it is a preferred object of the technology disclosed here to increase the safety and reliability of an energy storage unit. Further preferred objects may be apparent from the advantageous effects of the technology disclosed here. The objects are achieved by the subject matter of the independent claims. The dependent claims constitute preferred embodiments.

In one embodiment, the invention relates to an energy storage unit for storage of electrical energy, comprising (i) one or more energy storage cells, (ii) appropriately one or more carriers and (iii) appropriately one or more protective films disposed between the one or more energy storage cells and the one or more carriers.

The use of such protective films in the case of a thermal event can increase safety. In the case of such a thermal event, for example, an energy storage cell can give off electrically conductive particles at high speed and high temperature, which can result, for example, in a short circuit to a carrier. The use of one or more protective film(s) at the desired site(s) can prevent such a short circuit, and hence distinctly reduce the effect of a thermal event.

Energy storage can especially be used for storing electrical energy, especially for a (traction) engine of a motor vehicle. The energy storage cells may especially be designed for electrochemical storage of energy. The carrier(s) may especially be designed to ensure stability and securing outside the energy storage cells. The carriers are thus typically not those elements that secure the energy storage cells directly to a vehicle body or other structure. The carriers may, for example, be elongated, may have a particular cross-sectional profile, for example, and may be formed from a conductive material, for example, such as steel or aluminum.

The protective films may especially be films that are two-dimensional and may especially be flexible. They may thus be arranged in a simple and flexible manner. They can especially ensure prevention of any electrical contact between energy storage cells and carriers in the case a thermal event. Illustrative executions are discussed in detail below.

The protective films may especially be thermally stable up to at least 800° C., up to at least 1000° C. or up to at least 1200° C. This may mean more particularly that such a temperature is withstood for a predetermined period of, for example, 30 s or 60 s without any resultant changes in mechanical stability or chemical composition of such a protective film.

The carriers may especially form an electrical ground of the energy storage unit. This permits the use of a comparatively heavy and/or bulky structure for provision of an electrical ground. The protective films mentioned can especially prevent a short circuit in the event of a fault on account of the use of such an electrical ground.

The protective film(s) may especially be electrically insulating. This may mean more particularly that they can withstand a voltage of, for example, 3000 V for a period of, for example, 60 s. This has been found to be advantageous for typical applications.

More particularly, the protective film(s) may be thermally insulating. This may mean, for example, that a protective film can be subjected to a temperature of 1200° C. for a period of, for example, 60 s without any loss of electrical insulation capacity.

With the values mentioned, it is especially possible to achieve particularly reliable protection for typical applications. However, other values are also possible.

The protective film(s) may especially comprise a carrier material and one or two layer(s) applied to the carrier material. Such designs have been found to be stable and particularly suitable for the application of relevance here.

The layer(s) may especially be formed from mica or true mica. Such materials have particularly high electrical and thermal insulation capacity which is not lost even under the action of high-speed hot particles such as those of relevance here. True mica may be understood, for example, to mean common potassium mica, non-common potassium mica or non-potassium mica. Materials of this kind may especially be used.

The carrier material may especially be formed from polyethylene. This has been found to be advantageous since it is particularly tear-resistant and thermally stable.

However, it is also possible to use materials other than those mentioned, especially when they have suitable protection properties.

The one or more protective film(s) may especially have a thickness of at least 0.05 mm or at least 0.1 mm. Such a lower limit has been found to be advantageous with regard to the properties of relevance here.

The one or more protective films may especially have a thickness of not more than 0.1 mm or not more than 0.2 mm or not more than 0.3 mm. For typical applications, no greater thickness is required in order to achieve the properties of relevance here, and so it is possible to dispense with any greater thickness and hence save build space.

One, some or all protective film(s) may especially have been applied to at least one of the carriers. Thus, the carrier is protected directly and can additionally be used for securing of the protective films. The protective film may have been adhesive bonded to the carrier, for example. The carrier(s) may also have been wholly or partly coated with the protective film or some or all of the protective films. This can be effected, for example, by suitable coating methods. In particular, a surface of a carrier that faces the energy storage cells may have been wholly or partly covered with a protective film.

In one design, one, some or all protective film(s) is/are disposed at a distance from the carriers. This can achieve a protective effect even in front of the respective carrier, which allows, for example, further elements to be protected.

In one design, the energy storage unit may have one or more housings in which there are formed one or more chambers into which the energy storage cells especially partially extend. In this regard, reference may be made to the description given in this application with regard to housings and the employable designs. The variants disclosed may be employed correspondingly here too. Such a housing may especially serve to directly hold the energy storage cells and may, moreover, form the chambers that can especially be sealed with respect to ingress of water, as already mentioned elsewhere.

In one design, one, some or all protective film(s) may have been applied atop one or more of the housing(s). This can achieve a protective effect in the immediate vicinity of the energy storage cells.

The arrangements of protective films, i.e., in particular, the direct applying to a carrier, the arrangement spaced apart from the carrier and the applying to a housing, may especially also be combined with one another in one design.

In particular, one, some or all chamber(s) may have an opening sealed wholly or partly watertight by a cover element. In this regard, reference is made to the description given elsewhere. One, some or all cover elements may especially be formed by a respective protective film. In other words, the protective film may be used directly as cover element, meaning that it not only fulfills the protective function already described in the case of a thermal event but also seals the chamber, especially against the ingress of water. Reference is made to the details given elsewhere relating to the cover element.

It may also be the case that one, some or all protective film(s) have been applied atop at least one cover element in each case. Typically, the cover element here can have the effect of sealing against ingress of water, and the protective film achieves the protective function already mentioned above in the case of thermal events. More particularly, it may be the case that, in the case of such a thermal event, the cover element is damaged, but retains outflowing hot particles, such that a short circuit with respect to surrounding carriers is prevented.

In one design, one, some or all energy storage cell(s) may have at least one pressure relief opening, with a protective film disposed between one, some or all pressure relief opening(s) and at least one carrier. This allows the respective protective film to be positioned particularly advantageously, in which case it can especially achieve a particularly advantageous protective effect between a pressure relief opening and a carrier. In particular, it can cover a complete cross section between the pressure relief opening and a carrier, for example, a carrier of the cross section. It can thus especially prevent particles expelled from the pressure relief opening from reaching the carrier. A pressure relief opening may especially be understood to mean an opening or at least a weak section and/or one designed with an intended breakage site in a side wall of an energy storage cell, where such a pressure relief opening typically serves in the case of a thermal event to allow outflowing particles to flow out in a particular direction. This direction can be taken into account in the arrangement of protective films as mentioned.

In an advantageous design, one, some or all protective film(s) may completely cover a cross section between a carrier and one or more energy storage cells. They may also protrude beyond them. In particular, a theoretical three-dimensional structure may especially be contemplated, which is defined by outer edges of carriers on the one hand and energy storage cell(s) on the other hand. Transverse to a theoretical longitudinal extent of such a three-dimensional structure and/or parallel to a surface of the carrier that faces the energy storage cells and/or parallel to an end face of the energy storage cell, it is then possible to contemplate the cross section at a point along the longitudinal extent which is defined by the theoretical three-dimensional structure.

The energy storage cells may especially be designed as round cells and/or longitudinal axes of the energy storage cells may especially be aligned parallel to one another. This has been found to be advantageous for typical applications, with reference to the description given elsewhere. Other designs of energy storage cells and the arrangement thereof may, however, also be used. In particular, it is also possible to use pouch cells or prismatic cells.

The energy storage cells may thus, for example, also be designed as prismatic cells.

The carriers may especially mechanically stabilize the energy storage unit. For this purpose, they may, for example, be formed from metal, such as aluminum. They may also, for example, have a suitable cross-sectional profile, such as a rectangular profile.

The invention further relates to a motor vehicle having an energy storage unit as described herein. It is thus possible to achieve the advantages already mentioned. The energy storage unit may especially be disposed in a floor region and/or beneath a passenger compartment of the motor vehicle.

In other words, it has been recognized that cell terminals, for example, the plus and minus poles of a cell, and current- and voltage-conducting cell connectors may be locally very close to a mechanical structure component made of aluminum (electrical ground), thus resulting in very small distances between the voltage-bearing components and electrical ground. For example, in the case of an 800 V storage system, compliance with airgap distances and leakage gap distances may be important in order to avoid insulation faults, short circuits and other faults.

Lateral terminals may have the consequence, for example, that cell vents or pressure relief openings can also be positioned on the side of the cell. These function as a pressure relief valve for the cell and, in the case of thermal runaway of a cell, can expel a relatively large amount (>200 g) of electrically conductive particles with very high pressure (>7 bar), high velocity (about 300 m/s) and high temperature (>1000° C.) from the cell. The particle stream in the case of this type of cell module can then flow within the small distance between the aluminum crossbeam and the many terminals and cell connectors.

It is proposed, for example, to apply a barrier in the form of a component having both electrically insulating action and high-temperature-resistant thermally insulating action to the side of the cell module and hence to locate it between the crossbeam and the terminals. A particularly inexpensive and space-saving design can be effected, for example, by means of a mica adhesive tape (for example thinner than 0.1/0.2 mm) of high thermal stability (>1000° C.). All other materials having similar properties are likewise useful.

A thermal fault is regularly a fault in which an exothermic chemical reaction occurs. Such a fault can also be referred to as a thermal event/thermal runaway. The fault may especially be an event that brings about operationally non-standard and self-boosting production of heat in the individual cells. It would be possible under some circumstances for propagation to set in. Such a fault may be caused, for example, by an internal short-circuit in a single cell or by overheating.

The electrical energy storage unit is especially a unit for storage of electrical energy, especially at least one electrical (traction) engine. The energy storage unit typically comprises multiple energy storage cells that are designed as individual cells, and typically a multitude of such individual cells that form the electrochemical energy storage cells. In general, a multitude of individual cells is provided. For example, the energy storage unit may be a high-voltage battery.

Typically, the energy storage unit comprises at least one storage housing. The storage housing is appropriately a casing that surrounds at least the high-voltage components of the energy storage unit. Appropriately, the storage housing is gastight, such that any gases exiting from the storage cells are trapped. Advantageously, the housing may serve for protection from overheating, contact protection, intrusion protection and/or protection from moisture and dust.

The storage housing may have been produced at least partly from a metal. In particular, it may have been formed from aluminum, an aluminum alloy, steel or a steel alloy. The at least one storage housing of the energy storage unit may accommodate at least one or more than one of the following components: energy storage cells, components of the power electronics, safeguard(s) for interruption of the power supply to the motor vehicle, cooling elements, electrical conductors, control device(s). The energy storage unit may especially have elements to be cooled, especially energy storage cells and/or components of the power electronics of the energy storage unit. Appropriately, the components are pre-mounted in the motor vehicle before the module is assembled.

The energy storage cells may especially be designed as round cells for electrochemical storage of energy. A round cell is generally accommodated in a cylindrical cell housing (“cell can”). If there is operationally standard expansion of the active materials of the round cell, the housing in the transition region is put under tension. It is advantageously thus possible for comparatively thin housing cross sections to compensate for the forces that result from the bulging. The cell housing has preferably manufactured from steel or a steel alloy.

Typically, vent openings in the energy storage cell may be provided to allow gases formed to escape from the cell housing. It is also possible to provide just one degassing opening per storage cell or round cell. Advantageously in each case, there is at least one degassing opening per round cell disposed so as to enable degassing toward the outer sill in the installed position. The degassing opening may also be referred to as pressure relief opening.

The length-to-diameter ratio of the energy storage cells or round cells preferably has a value between 5 and 30, preferably between 7 and 15, and more preferably between 9 and 11. The length-to-diameter ratio is the quotient of the length of the cell housing of the round cell in the numerator and the diameter of the cell housing of the round cell in the denominator. In a preferred configuration, the round cells may have, for example, an (outer) diameter of about 45 mm to 55 mm. Also advantageously, the round cells may have a length of 360 mm to 1100 mm, preferably of about 450 mm to 600 mm, and more preferably of about 520 mm to 570 mm.

In a preferred design, the energy storage cells or round cells, in the installed position, run essentially parallel (i.e., parallel, possibly with variances that are immaterial to the function) to the transverse vehicle axis Y. The transverse vehicle axis is that axis which runs perpendicularly to the longitudinal vehicle axis X and horizontally in the normal position of the motor vehicle. However, the energy storage cells may also run parallel to the longitudinal vehicle axis X. They may also be arranged differently.

The energy storage cells are typically disposed in several layers within the storage housing in the direction of the vertical vehicle axis Z. The vertical vehicle axis is the axis that runs perpendicularly to the longitudinal vehicle axis X and vertically in the normal position of the motor vehicle. A layer of energy storage cells is especially a multitude of energy storage cells that are installed in the same plane in the storage housing and are at essentially the same distance from the base of the storage housing. Advantageously, the number of layers varies in the direction of the longitudinal vehicle axis X. In one design, the storage housing may have a top face matched in terms of its housing contour to the lower inner contour of a passenger cell of the motor vehicle, in which case, in the installed position, the total height of the several layers, for adaptation to the housing contour in the direction of the longitudinal vehicle housing, is varied in that, in a first region of a layer, directly adjacent round cells in the layer, in the installed position, are spaced further apart in the direction of the longitudinal vehicle axis than directly adjacent round cells in a second region of the same layer, such that, advantageously, in the first region, a further round cell in another layer penetrates further in a first intermediate region formed by the round cells that are immediately adjacent in the first region than a further round cell of identical design in the other layer penetrates in a second intermediate region formed in the second region of immediately adjacent round cells. The total height of the several layers is measured from the base of the storage housing up to the upper end of the uppermost layer at the respective point in the storage housing. The inner contour of the passenger cell is the contour that bounds the interior of the passenger cell accessible to a user of the vehicle. In particular, the housing contour may be matched to the inner contour such that an appropriately uniform gap is provided between the top side of the storage housing and the inner contour of the passenger cell, which is preferably less than 15 cm or less than 10 cm or less than 5 cm.

In one design, at least one lowermost layer of the multiple layers in the installed position of the energy storage unit may extend in the direction of the longitudinal vehicle axis from a front foot region of the storage housing that adjoins the front footwell of the motor vehicle in the installed position up to a seat region of the storage housing, with the seat region adjoining the rear passenger bench of the motor vehicle.

In one design, there may be fewer layers disposed in at least one of the foot regions of the storage housing adjoining the front or rear footwell of the motor vehicle than in a seat region of the storage housing, with the seat region adjoining the front seats and/or the rear seats (for example, single seats or rear seat bench) of the motor vehicle. It may thus advantageously be the case that, for example, only a lowermost layer of energy storage cells is provided in the storage housing in the front and/or rear footwell, whereas multiple layers are provided stacked one on top of another in the front and/or rear seat region. This has the advantage that, in particular, the build space to the front seats or below the rear seats can be utilized more efficiently in order thus to improve the electrical storage capacity of the motor vehicle.

In one configuration, it may be the case that the multitude of energy storage cells of a layer are connected to one another by an adhesive applied over the multitude of energy storage cells in the same layer. Appropriately, the adhesive may be applied only after the individual energy storage cells of a layer have been positioned relative to one another, for example after the arrangement of the energy storage cells in the storage housing. Advantageously, it is thus possible to fix the individual energy storage cells of a layer relative to one another in an inexpensive and space-saving manner. The adhesive used may, for example, be polyurethane, polyamide or polyethylene.

In one design, cooling elements for cooling of the energy storage cells that may be provided between at least two layers of the energy storage cells may preferably at least partly have a corrugated design in the cross section perpendicular to the transverse vehicle axis Y. In one configuration, the cooling elements may be connected to the cooling circuit of the motor vehicle.

There follows a description of the further technical aspects and configurations, which are independent of other aspects of the invention described herein, especially relating to the use of protective films. However, they may be combined therewith.

These technical aspects relate to an energy storage unit comprising (i) a plurality of energy storage cells and (ii) appropriately one or more chambers into which the energy storage cells extend partially. One, some or all cell terminal(s) of the energy storage cells are appropriately disposed in the one or more chambers.

In one design, one, some or all chamber(s) is/are sealed against penetration of water by means of one or more seals at the energy storage cells that extend into them.

In one design, one, some or all chamber(s) has/have an opening which is wholly or partly closed against ingress of water by a cover element.

By means of such a design, the cell terminals may be at least partly protected against water. Water can get to an energy storage unit, for example, when it penetrates from the outside or when a cooling system has a leak. By virtue of the design disclosed here, contact of the water with the cell terminals of the energy storage cells can be prevented, such that unwanted effects, for example short circuits or the formation of hydrogen, are prevented.

Sealing of a chamber or another element against ingress of water may be understood to mean, for example, a watertight design. This may mean, for example, that no water can penetrate into the chamber or at a particular point up to a defined pressure of, for example, 1, 5 or 10 bar. However, sealing against ingress of water may, for example, alternatively also be understood to mean protection against splashed water, such that, for example, no water penetrates into the chamber at least in the case of spraying with splashed water up to a certain pressure. The respective design may especially be chosen depending on what water exposure is realistically to be expected. If the energy storage unit is installed, for example, at the site where surrounding water is regularly to be expected, for example because the energy storage unit is below the fording depth of a motor vehicle without further ensheathing or the vehicle is amphibious, it is possible, for example, to choose a watertight design. If the sealing is to be provided especially for the case that a cooling system leaks, the amount of water to be expected can be estimated and the seal can be designed depending thereon.

The energy storage unit can especially store electrical energy for operation of a (traction) engine of a motor vehicle. However, it can also be used for other purposes. Any energy storage cell typically has a respective sheath or other delimitation, and the energy storage cells can typically be handled separately at least before the assembly of the energy storage unit. In particular, any energy storage cell may have two cell terminals, one of which is the plus pole and one the minus pole. The cell terminals are typically designed with electrical wires exposed to the outside, such that current flow is possible in principle when these conductors come into contact with water.

The chambers may be formed, for example, in a housing, which will be discussed in more detail further down. The chambers may also be part of another element which may especially also have other functions, for example reinforcing or load-bearing functions. Typically, one end of a respective energy storage cell extends into one of the chambers, in which case the chamber is typically closed thereby at the corresponding point. A chamber typically has one open receptacle for each energy storage cell to be accommodated, in which an energy storage cell can be accommodated.

What is meant by an energy storage cell extending partially into a chamber may especially be that a portion of the energy storage cell, especially a portion adjoining a longitudinal end, is present in the chamber or an adjoining receptacle, and the rest of the energy storage cell protrudes therefrom.

In principle, any space which is wholly or at least partly surrounded and into which at least one energy storage cell can extend may be regarded as a chamber. In the design disclosed here, such a chamber may especially be wholly or partly sealed, especially with respect to penetration of water, as mentioned elsewhere.

It is possible to accommodate all cell terminals in one of the chambers, or else it is possible for some cell terminals not to be accommodated in chambers. This depends on whether all cell terminals are to be protected or whether just a portion of the cell terminals are to be protected.

In one design, the energy storage unit has a first housing in which one, some or all chambers are formed. Such a housing may, for example, be a housing which is used specifically within the energy storage unit to accommodate and/or hold the energy storage cells and/or to form chambers. However, it may also be a housing having further functions, for example the establishment of stability or safety, for example with respect to side impact events or other accidents. The chambers may especially take the form of cavities in the housing, in which case this can be accomplished, for example, by using a corresponding tool, for example in the injection molding, or by removal of material.

It is especially possible for first longitudinal ends of the energy storage cells to extend into the first housing. For example, each energy storage cell may have a respective first longitudinal end and an opposite respective second longitudinal end. The first longitudinal ends may, for example, be arranged alongside one another, for example when the energy storage cells extend parallel to one another. For example, exactly one cell terminal may be disposed at each longitudinal end, or else two cell terminals may be disposed at one longitudinal end.

The housing may, for example, be a module frame. Such a module frame may also serve, for example, to secure the energy storage cells. It may run or extend, for example, along longitudinal ends of the energy storage cells disposed adjacent to one another.

In one design, the energy storage unit has a second housing in which one or some of the chambers are formed. The elucidations relating to the first housing are correspondingly applicable to the second housing. In particular, two of the opposite longitudinal ends of the energy storage cells from the first longitudinal ends may extend into chambers of the second housing. Thus, the second housing may have a function corresponding to the first housing, which has already been described by way of example. In particular, the two housings may hold the energy storage cells, which may be arranged parallel to one another, for example, at each end and/or form respective chambers for the energy storage cells that are sealed against ingress of water.

In particular, one of the housings or both housings may be designed as a holder for the energy storage cells. This may mean, more particularly, that the housing(s) secure(s) the energy storage cells in such a way that they hold them relative to the housing or to a structure surrounding the housing(s), for example, a vehicle body. This can especially be effected by means of mechanical securing, for which illustrative designs are given below.

In one design, the energy storage cells are designed as round cells. For this purpose, the design described herein has been found to be particularly useful, since round cells can be introduced in a simple manner and can be protected from water in a simple manner. In principle, however, it is also possible to use other designs of cells.

The energy storage cells may especially each have a first cell terminal and a second cell terminal. The first cell terminal and the second cell terminal may especially be disposed at opposite longitudinal ends of the energy storage cells. This corresponds to a design of energy storage cells, for example as round cells, in which the cell terminals are not adjacent to one another, but in which, for example, there is a plus pole at one longitudinal end and a minus pole at the opposite longitudinal end. This permits, for example, interconnections by means of cell connectors, in which case such cell connectors can achieve either parallel connection or series connection or combinations thereof in a simple manner.

In particular, longitudinal axes of the energy storage cells may be aligned parallel to one another. This permits a simple and particularly space-saving arrangement. It is likewise possible in the case of such an arrangement, in a simple manner, to take account of construction-related circumstances, such that build spaces can be exploited in the best way possible. For example, the build space may be one beneath a passenger cell of a motor vehicle. This typically has a height that varies in a longitudinal direction of the motor vehicle. By variation of the number of layers of energy storage cells, it is thus possible to adapt the energy storage unit in the best way possible to the build space available. A longitudinal direction of the motor vehicle is typically that direction in which a motor vehicle travels with the steered wheels straight.

In one design, the energy storage unit may have one or more cell connectors, where cell terminals of the energy storage cells may be electrically connected to one another by the cell connectors in the chambers. Such cell connectors may especially achieve desired parallel or series connections or combinations thereof, such that charging and withdrawal of electrical energy from the energy storage unit are enabled in the desired manner. Cell connectors of this kind may especially likewise be present in the chambers, such that they can be wholly or at least partly protected from surrounding water. However, it is also possible to position at least some of the cell connectors outside the chambers if such protection is unnecessary.

In one design, there is exactly one cell connector in each case in one, some or all chamber(s). Such a cell connector may especially connect cell terminals of at least two energy storage cells. It may, for example, connect cell terminals of two, three or four energy storage cells to one another, such that desired series or parallel connections or combinations thereof can be achieved. In a design in which there is exactly one cell connector in a chamber, the chamber typically protects the cell connector and the cell terminals connected thereto, such that separate chambers are formed for other cell connectors and cell terminals connected thereto.

In one design, there is more than one cell connector in each case in one, some or all chambers. As a result, it is possible to use more expensive chambers that protect multiple cell connectors and the cell terminals connected thereto.

In one design, the chambers make contact with energy storage cells that extend into the respective chamber mechanically by contact regions, where the contact regions are especially designed to be complementary to the energy storage cell. In this way, it is possible to achieve simple sealing and additionally also mechanical securing. Mechanical contacting may be understood, for example, to mean that the chamber or a structure that forms the chamber, for example a housing already mentioned further up, directly adjoins an energy storage cell that extend into it.

In one design, one, some or all chambers are sealed against ingress of water by means of one or more seals at the energy storage cells that extend into them. Such a seal may especially be used in addition to a surrounding structure, for example a housing, in order to achieve a particularly effective sealing action. Possible designs are specified hereinafter.

One, some or all seals may be designed, for example, as a seal that respectively surrounds an energy storage cell. This permits a circumferential sealing effect. One, some or all seals may be designed, for example, as O rings. This enables a simple design. One, some or all seals may be formed, for example, from an elastomer material. They may also be designed by two-component injection molding on the housing. Such designs have been found to be advantageous for typical applications.

Two-component injection molding may especially be understood to mean a method of manufacturing a component from two plastics. This permits, for example, the production of a firmer and stiffer plastic for the holding function and of a softer plastic for the sealing function. A sealing component may be formed, for example, from ethylene-propylene-diene rubber (EPDM).

In one design, one, some or all energy storage cell(s) is/are mechanically secured by adhesive, where the adhesive preferably forms one, some or all seals. The securing may especially be effected on a housing or on a surrounding structure, especially on a structure in which the chambers are formed. For example, the adhesive used may be a 2K polyurethane adhesive, a two-component acrylate-based adhesive, a PUR adhesive or an epoxy resin. However, other adhesives are also possible.

In one design, one, some or all seal(s) is/are disposed in grooves that may especially be formed on the chamber side. What this means is more particularly that a groove is formed in a housing or in another structure in which the chamber is formed, where the respective seal at least partly engages into this groove. The seal may especially be held in position by the groove, especially in such a way that it fulfills its sealing effect with respect to the energy storage cell.

In one design, some or all seals are designed as at least one molding that makes contact with multiple energy storage cells. This can enable a particularly simple design since one molding can be used simultaneously for the formation of multiple seals. Such a molding may especially be an elastomer molding. For example, it is possible to use a silicone, EPDM and/or PUR foam for the molding. The molding may especially be manufactured separately from a housing and may be applied to the housing or at least partially inserted into the housing, and then the energy storage cells may be introduced, in order to be sealed by the molding which is present partially between the energy storage cells and the housing.

The molding may especially be an element which, in its resting state, has a particular shape, for example the one described below with a mat and annular sections. This does not mean that the molding cannot be elastic and/or flexible.

The at least one molding may especially be designed as a mat at least between the energy storage cells. A mat may especially be understood to mean a two-dimensional section of the molding with a thickness which is completely or at least essentially the same. The mat may especially be of a two-dimensional design. This permits simple production and space-saving use of the molding.

The at least one molding may especially have multiple band- or ring-shaped regions, where each band- or ring-shaped region surrounds an energy storage cell and makes sealing contact with the energy storage cell. An annular region may especially be circular in cross section. A band-shaped region is a generalization of this, such that, for example, adaptation to energy storage cells with a non-round cross section is possible. The band- or ring-shaped regions may especially display a sealing effect, such that the desired sealing effect against penetration of water is achieved between the annular region and energy storage cell. The band- or ring-shaped regions may especially be directly connected on the outside to a region in the form of a mat, such that no penetration of water is possible here either on account of the configuration of the molding.

The molding may especially be fashioned from a watertight material.

The seals may especially be disposed in the contact regions and/or form the contact regions. The seals may thus also fulfill the function of contacts and, for example, hold the energy storage cells. The same applies if only one seal or only one contact region is present.

The chambers may especially be sealed against penetration of water at least up to a defined water level in an upward direction. This may mean, for example, that no water runs into the chambers up to a particular water level, but water can run into the chambers in the case of a higher water level, in which case it can run, for example, through a seal, for example the sealing element described further down. Such a design may be chosen, for example, when the main source of surrounding water is a cooling water circuit that may have a leak, and in which a maximum expected water level can be calculated on the basis of the known amount of the maximum outflow of cooling water. It is then possible to dispense with complete sealing of the chambers, for example, which enables a simpler design and easier maintenance. This is also true, for example, when only one chamber is used.

However, the chamber(s) may also be completely sealed against penetration of water. This may mean, more particularly, that even in the case of complete immersion of the chamber or of an element that forms the chamber into water, no water will penetrate into the chamber. This can likewise mean all-round protection against splashed water.

In one design, one, some or all chamber(s) has/have an opening which is wholly or partly sealed against ingress of water by a cover element. By means of such an opening, it is possible, for example, to simplify the production since it can be used, for example, to mount cell connectors after the energy storage cells have been inserted into the structure that forms the chambers, especially from the other side. The opening can then be sealed wholly or partly against ingress of water by means of the cover element, in which case reference is made to the details given elsewhere with regard to possible configurations. The opening may thus especially bring about easy accessibility of the chamber. It may especially be arranged in such a way that no energy storage cells pass through the opening.

In particular, one, some or all cover element(s) may be designed as a film. This has been found to be a simple and favorable design. A film may especially be a two-dimensional element, for example made of a plastic. In particular, one, some or all cover elements may be designed as a lid. This can achieve simple covering of the opening. In particular, one, some or all cover elements may be formed from plastic. For example, polyethylene (PE), polyethylene terephthalate (PET), polystyrene (PS) or expanded polystyrene (EPS) may be used for this purpose. Such designs have been found to be advantageous for typical applications.

In one design, one, some or all chambers are sealed by sealing adhesive at the cover elements. This can achieve the desired sealing effect. For example, it is possible for this purpose to use pressure-sensitive adhesives, silicones, PUR rubbers or epoxy resins. However, other possible designs are also conceivable.

In one possible design, one, some or all cover elements are latched in. This may especially mean that a form-fitting connection is formed between the cover element and housing or other structure. In particular, in the case of a cover element latched into a housing, a latching geometry may be formed on the cover element and/or the housing. Such a latching geometry may be formed, for example, by initial shaping of the cover and or by means of recesses in the housing, such that the form-fitting connection already mentioned is formed when the cover element is pushed on in a suitable manner.

In particular, one, some or all cover elements may be latched in with a latching geometry that seals against penetration of water. Thus, the latching geometry can achieve the desired sealing effect, for example by multiple deflection of an intermeshing sealing element in a recess provided for the purpose.

In particular, one, some or all cover elements may be latched into a housing. In particular, the chambers may be formed in the housing, and openings in the chambers may be closed by means of one or more cover elements. For example, one cover element may be used for all chambers and a housing, in which case such a housing may extend, for example, along a complete side of energy storage unit, which may be defined, for example, by mutually adjacent longitudinal ends of the energy storage cells. However, it is also possible to use other designs. Alternatively or additionally, one, some or all cover elements may be joined and/or sealed to a housing by means of plastic welding. This may additionally be used for latching-in, or else as an alternative thereto. Typically, plastic welding can simultaneously achieve a securing effect, and also a sealing effect. It is possible here, for example, to form welding beads. In this case too, it is possible to use a seal manufactured as a two-component injection molding. This may especially be a favorable solution when two-component injection molding is used in any case for the sealing to give energy storage cells.

The opening of one, some or all chambers may especially be disposed opposite contact regions of the chamber with energy storage cells that extend into them. This enables accessibility of cell terminals of the energy storage cells through the opening in a particularly simple manner, which can be used, for example, for mounting of cell connectors.

The cover element may especially extend with sealing against penetration of water up to a defined water level in a vertical direction. This can achieve sealing up to such a water level. Reference may be made to the details given elsewhere in this regard. Such a design may be used solely for one cover element, for multiple cover elements or else for all cover elements.

The cover element may also completely seal the opening, some openings or all openings. This can achieve an even better protective effect. Such a design may be used solely for one cover element, for multiple cover elements or else for all cover elements.

The energy storage cells may especially be arranged in one or more layers. This arrangement may be advantageous especially in order to exploit build spaces of variable height in the best possible way, which can increase the transportable storage capacity. The number of layers may thus vary, for example, in a longitudinal direction of the motor vehicle or else in another direction.

The energy storage unit may especially have one or more cooling elements disposed between energy storage cells. Cooling liquid in particular may be routable through the cooling elements. The cooling liquid may, for example, be water, especially with additives, or a coolant. A coolant typically exploits the liquid-gaseous phase transition. For the cooling liquid, for example, suitable channels may be formed in the cooling elements. It has been found that the design disclosed here offers particularly good assurance against any leaks in the cooling elements or a surrounding cooling system, since the cell terminals and cell connectors are protected advantageously against any escaping cooling liquid.

The invention further relates to a motor vehicle having an energy storage unit as described herein. With regard to the energy storage unit, it is possible to use any of the designs described herein. The energy storage unit may especially be disposed in a floor region and/or beneath a passenger compartment of the motor vehicle.

In other words, it has been recognized that, in cell modules or energy storage cells known from the prior art, cell terminals of the cells (for example, plus/minus poles) are fundamentally exposed to the environment. The cell contacting system is typically welded on in the assembly operation. It may be a complex geometric system which is difficult to seal. Since cell terminals fundamentally have different electrical voltage levels, there can be stray currents in the case of wetting of several terminals simultaneously with conductive liquid. This can lead to corrosion or other unwanted processes.

By means of a simple two-dimensional plastic film or a plastic lid which can be applied in a particularly simple manner, for example in the case of a module designed with large horizontal cylindrical cells, it is possible to achieve two-dimensional sealing of a module frame from the outside. For this purpose, the module frame is made, for example, such that the cell terminals are within the frame. In order to seal the circumferential edge, it is possible, for example, to apply a sealing adhesive (for example, a one- or two-component adhesive). It is also possible to make the plastic lid such that a latching geometry is formed at the edges, via which sealing is likewise achieved.

In addition, by means of a simple circumferential seal on the side of a cell can, which can be applied in a particularly simple manner, for example, in the case of a module concept with large horizontal cylindrical cells, it is possible to achieve a circumferential seal of the cell can for incorporation in a plastic frame. For this purpose, there are various methods and/or components with which the sealing effect can be configured very simply and in particular also in a simple manner for production and assembly.

Aspects of the invention and working examples will now be described with reference to figures. The figures show:

### BRIEF DESCRIPTION OF THE DRAWINGS

FIG. 1: an energy storage unit,

FIG. 2: one design of a seal,

FIG. 3: a further design of a seal,

FIG. 4: the seal of FIG. 3 in another view,

FIG. 5: a detail from an energy storage unit with closed opening,

FIG. 6: a detail from an energy storage unit with closed opening in an alternative design,

FIG. 7: a detail from a further energy storage unit with protective film,

FIG. 8: a detail from a further energy storage unit with protective film,

FIG. 9: a detail from a further energy storage unit with protective film,

FIG. 10: a detail from a further energy storage unit with protective film,

FIG. 11: a detail from a further energy storage unit with protective film, and

FIG. 12: a further energy storage unit.

### DETAILED DESCRIPTION OF THE DRAWINGS

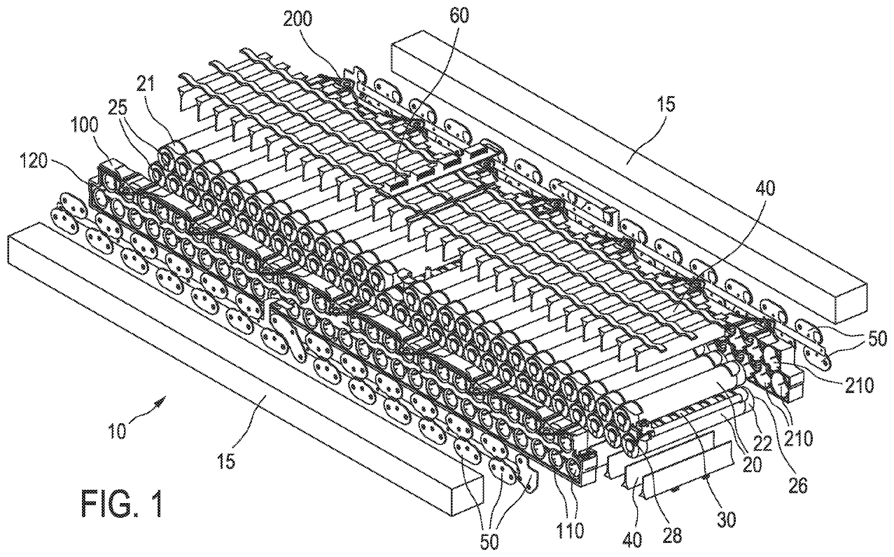

FIG. 1 shows, in purely schematic form, in an exploded view, an energy storage unit 10 in a general form, with elucidation of working examples hereinafter on the basis of this energy storage unit 10.

The energy storage unit 10 has two carriers 15 that are shown schematically at the side and ensure mechanical stability. For example, they may be part of a housing (not shown in detail). They may especially be formed from aluminum and may form a ground for the energy storage unit 10.

The energy storage unit has multiple energy storage cells 20. In the present context, these take the form of round cells and have a respective longitudinal direction that in the present case extends transverse to the longitudinal extents of the carriers 15. The energy storage cells 20 are arranged such that their longitudinal directions are parallel to one another. The energy storage cells 20 in the present case are arranged into layers, with the upper layer interrupted once in the middle, since a control element 60 is present at this point. The control element 60 may perform functions such as temperature monitoring or control of charging and withdrawal functionality, for example. This will not be addressed here in detail.

Each energy storage cell 20 has a first longitudinal end 21 and a second longitudinal end 22. The longitudinal ends 21, 22 lie opposite one another viewed along the respective longitudinal axis of the energy storage cell 20. At the first longitudinal ends 21, which, as can be seen in FIG. 1, are arranged directly adjacent to one another, are disposed the respective first cell terminals 25. These may form a plus or minus pole of the respective energy storage cell 20 and constitute a terminal of the energy storage cell 20. They typically have electrical wires exposed to the outside, to which, for example, wires or cell connectors may be connected. At the second longitudinal end 22 are disposed corresponding second cell terminals 26, but these are concealed in FIG. 1 and hence cannot be seen.

At the first longitudinal end, in the present case, respective pressure relief openings 28 are formed in the energy storage cells 20 at the interface. These are regions of low wall thickness, such that, in the case of a thermal event, hot particles are blown out specifically at the pressure relief opening.

A cooling element 30 that runs between the two layers of the energy storage cells 20 is designed to conduct cooling liquid. By means of such a cooling liquid, the energy storage unit 10 can thus be cooled, in which case heat formed, for example, in the charging or in the withdrawal of current can be removed.

Above and beneath the energy storage cells 20 are disposed insulation elements 40 that partly surround the energy storage cells 20 and in the present case are formed from a thermally insulating foam. This permits thermal insulation of the energy storage unit 10.

At the side of the energy storage cells 20, i.e., adjoining the longitudinal ends 21, 22, in the present case are disposed a first housing 100 and a second housing 200. Formed in the first housing 100 are receivers 110 into which the first longitudinal ends 21 of the energy storage cells 20 can be inserted. In this way, the energy storage cells 20 are held in place. Likewise formed in the second housing 200 are receivers 210 into which the second longitudinal ends 22 of the energy storage cells 20 can be introduced. The energy storage cells 20 are also held therein.

In the first housing 100, on the side facing the viewer in FIG. 1, is disposed a chamber 120. In the assembled state, the receivers 110 open directly into this, and the chamber 120, in the design shown, is open to the outside, i.e. opposite the energy storage cells 20. The chamber 120 in this case extends across all the receivers 110, i.e. in the present case along the entire longitudinal extent of the housing 100.

For connection of the first cell terminals 25, multiple cell connectors 50 are provided, which, in the installed state, are disposed in the chamber 120. In this way, the energy storage cells 20 are interconnected in the desired manner, and parallel and/or series connection can be implemented in a simple manner.

As shown, the chambers 120 are open to the outside, such that, for example, in the case of a leak in the cooling element 30, cooling fluid that escapes can reach the cell connectors 50. This can lead, for example, to corrosion or to decomposition of the cooling fluid. In order to avoid this, the measures described hereinafter may be provided. With regard to the elements visible in the figures described hereinafter, which can also be seen in FIG. 1, reference is made to the description of FIG. 1, unless specified otherwise hereinafter.

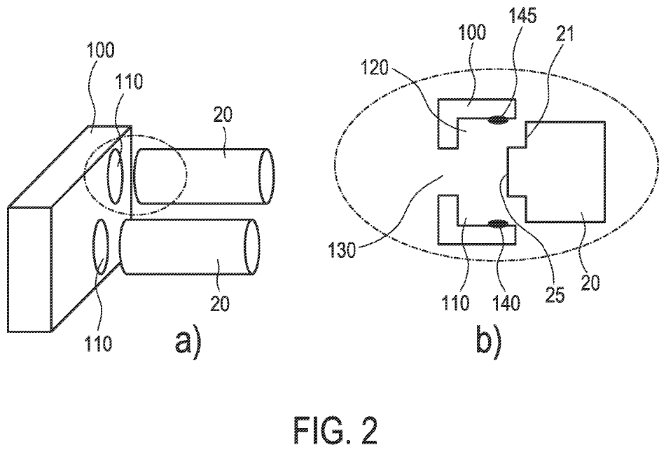

FIG. 2 shows a possible seal of a chamber 120. FIG. 2a shows the basic install situation of the energy storage cells 20 into the first housing 100, with a framed region shown in enlarged form in FIG. 2b. It can be seen here that a seal 140 is provided within the housing 100 and especially within a receiver 110. This seal 140 in the present case is designed as an O ring. It is disposed in a groove 145 which is formed on the chamber side in the receiver 110 and defines the position of the seal 140. If the energy storage cell 20, proceeding from the state shown in FIG. 2b, is moved further to the left, it will mesh into the chamber 120 and come into contact with the seal 140 on the outside. In this way, the chamber 120 is sealed against penetrating water at its contact region with the energy storage cell 20. Depending on the desired design, it is possible here to achieve a watertight design, for example up to a particular static pressure, or else a seal against any splashed water.

The seal 140 may especially be fashioned from an elastomer. It may also be fashioned as a two-component sealing element molded on by injection molding, for example in the way as already described further up.

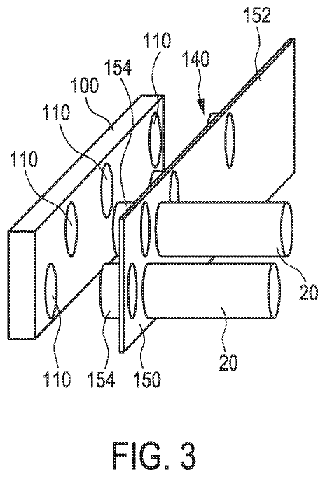

FIG. 3 shows an alternative design of the seal 140. The seal 140 is designed as a molding 150 consisting of an elastomer material. The molding 150 is formed partly as a mat 152 that constitutes a two-dimensional region with a thin constant extent along the longitudinal axes of the energy storage cells 20. Additionally, formed in the molding 150 are multiple annular regions 154 which, as shown, point in the direction of the first housing 100. The annular regions 154 are designed such that the energy storage cells 20 can be pushed through and can be introduced together with the annular regions 154 into the receivers 110 such that the respective annular region 154 lies between the energy storage cell 20 and receiver 110. Typically, by suitable choice of the geometric ratios, it is possible to achieve pressing, such that the respective annular region 154 is compressed between the energy storage cell 20 and receiver 110. This can achieve a desired seal at this point. The mat 152, which is typically in one-piece form with the annular regions 154, ensures sealing between the receivers 110.

The use of the molding 150 makes it possible to achieve particularly simple production since the molding 150 can be handled as such and can bring about the sealing effect simultaneously for all encompassed energy storage cells 20.

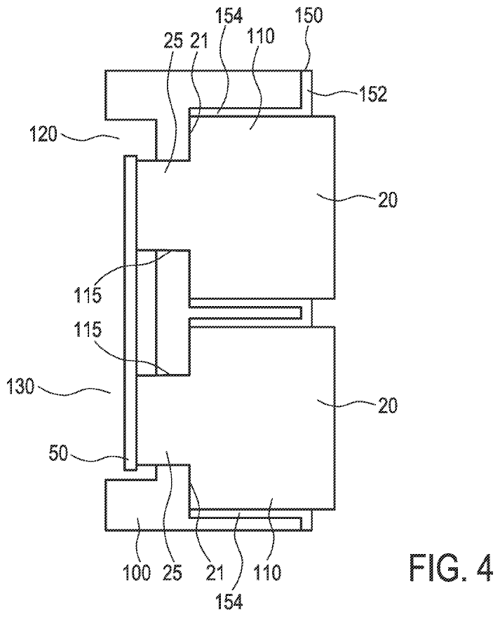

FIG. 4 shows the design of FIG. 3, i.e. with molding 150, in an assembled state. It can be seen here that the annular regions 154 of the molding 150, as already mentioned, are disposed between the energy storage cell 20 and the receiver 110 or the section of the housing 100 that forms the receiver 110 and are compressed at that point. On the left-hand side, a cell connector 50 can be seen, which is disposed in the chamber 120 and ensures the connecting of two energy storage cells 20 in the present case. An opening 130 of the chamber 120 is open in the present case, but can be closed and sealed as described in detail further down.

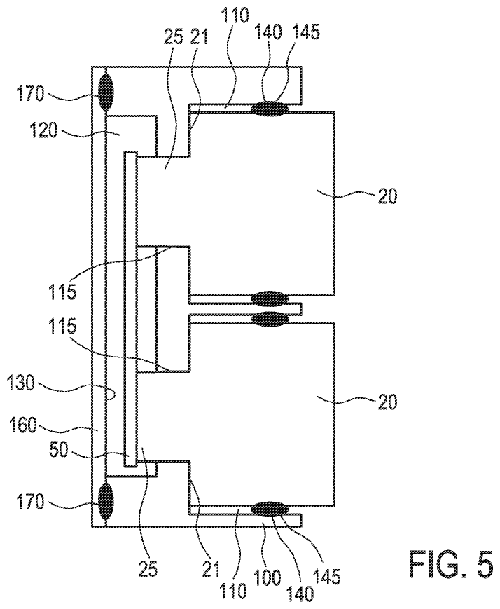

FIG. 5 shows a design similar to that of FIG. 2b, wherein, in the present case, two energy storage cells 20 are disposed in respective receivers 110. These are sealed in the respective receiver 110 by a seal 140 designed as an O ring in each case. The first cell terminals 25 extend into the chamber 120, passing through respective passages 115. The passages 115 are formed in the first housing 110. A cell connector 50 is disposed in the chamber 120. The chamber 120, as already mentioned, has an opening 130 which, in the design shown in FIG. 5, is closed by means of a cover element 160. The cover element 160 is correspondingly placed onto and mounted on the first housing 100.

In order to secure the cover element 160 at the first housing 100, in the present case, a plastic welding method was used, such that weld beads 170 are formed between the first housing 100 and cover element 160. These weld beads seal the connection between the cover element 160 and first housing 100 with the desired sealing effect.

The combination of seal 140 and cover element 160 can thus achieve an overall seal of the chamber 120, meaning that the chamber 120 is sealed completely at least to the desired degree. For example, this may mean a complete seal up to a particular static pressure or a complete seal against splashed water.

Alternatively, for example, rather than the seal 140 as shown in FIG. 5, the molding 150 may also be used for sealing on the side of the energy storage cells 20.

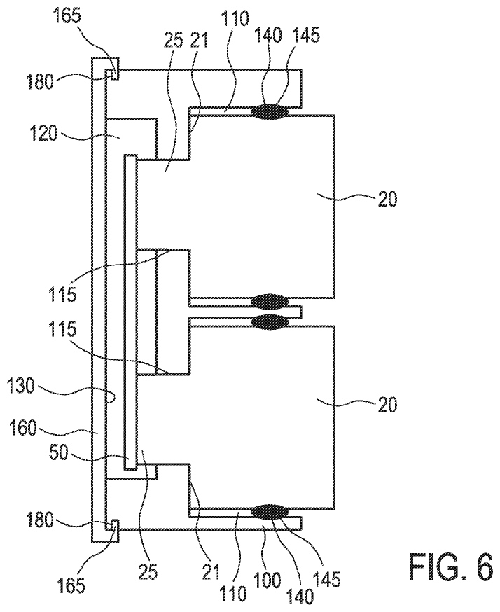

FIG. 6 shows an alternative design by comparison with FIG. 5, wherein the cover element 160 is secured to the first housing 100 not by means of plastic welding but by latching-in. For this purpose, the cover element 160 has a latching geometry 165, and the first housing 100 has a complementary recess 180. The latching geometry 165 and recess 180 are designed such that the forces that arise on latching generate the desired sealing effect. This design of the cover element 160 is also combinable with other designs of a seal on the cell side.

The sealing concepts that have been described so far may be used correspondingly on the opposite side, i.e. on the second housing 200. The corresponding designs may, for example, be mirror-symmetric to the designs described.

The figures that follow show designs relating to the use of a protective film. Such a protective film may especially be used in addition to the sealing measures described with regard to the preceding figures. However, they may also be used independently thereof.

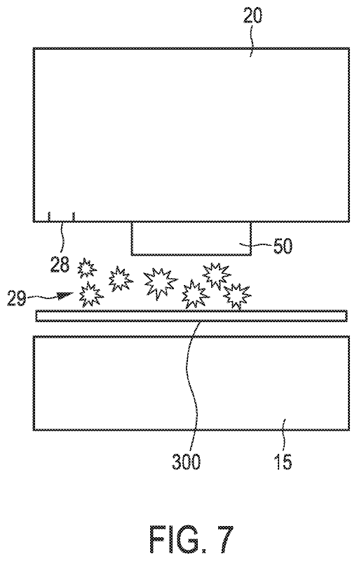

FIG. 7 shows a detail from an energy storage unit 10, showing an energy storage cell 20 with cell connector 50 mounted thereon and an adjacent carrier 15. As already mentioned with regard to FIG. 1, the energy storage cell 20 has a pressure relief opening 28, which is aligned such that, in the case of a thermal event, high-speed and hot particles 29 are thrown in the direction of the carrier 15. Without suitable protection, this could lead to a short circuit against the carrier 15 used as ground.

In order to prevent this, in the present case, a protective film 300 is disposed between energy storage cell 20 and carrier 15, such that the particles 29 mentioned do not reach the carrier 15. The protective film 300 is especially formed from polyethylene as carrier material, and mica applied thereto, and such a protective film 300 has particularly advantageous properties in that it can withstand a stream of particles at a temperature of 1200° C., for example, for a relevant period of time of 60 s, for example. The mechanical strength and electrical insulation are typically not lost. The short circuit mentioned can thus be prevented, and further malfunctions on account of the thermal events can be avoided.

The protective film in FIG. 7 and the subsequent figures also extends perpendicular to the plane of the paper.

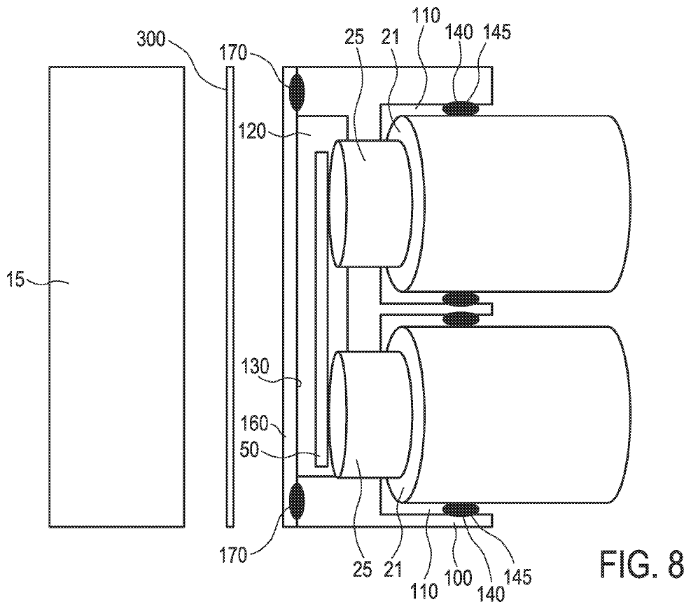

FIG. 8 shows a design similar to FIG. 5, additionally showing the carrier 15 and a protective layer 300 disposed in between. The protective film 300 is secured freely between the carrier 15 and cover plate 160, although FIG. 8 does not show a corresponding means of securing.

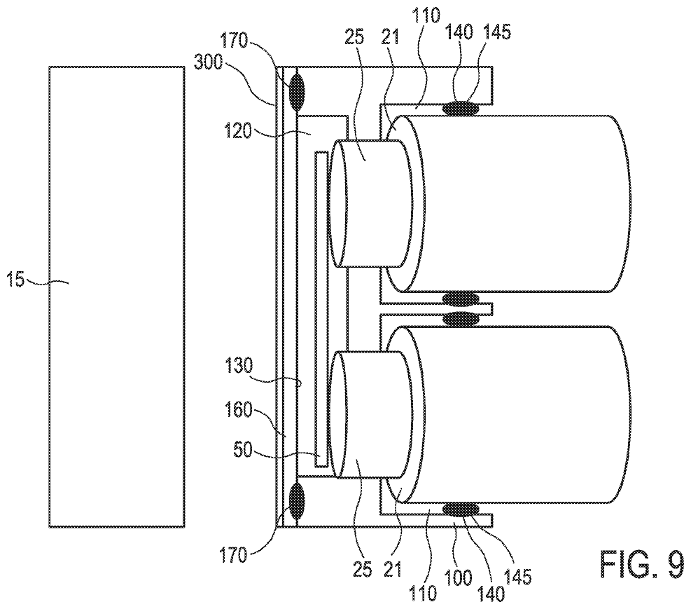

FIG. 9 shows an alternative design by comparison with FIG. 8, wherein the protective film 300 has been applied directly to the cover element 160. Thus, the cover element 160 serves as holder for the protective film 300. The protective film 300 may, for example, be applied by adhesive bonding or secured by means of a screw connection. As an alternative to the design shown in FIG. 9, it would also be possible to use the protective film 300 only, which in that case may especially also assume the function of the cover element 160.

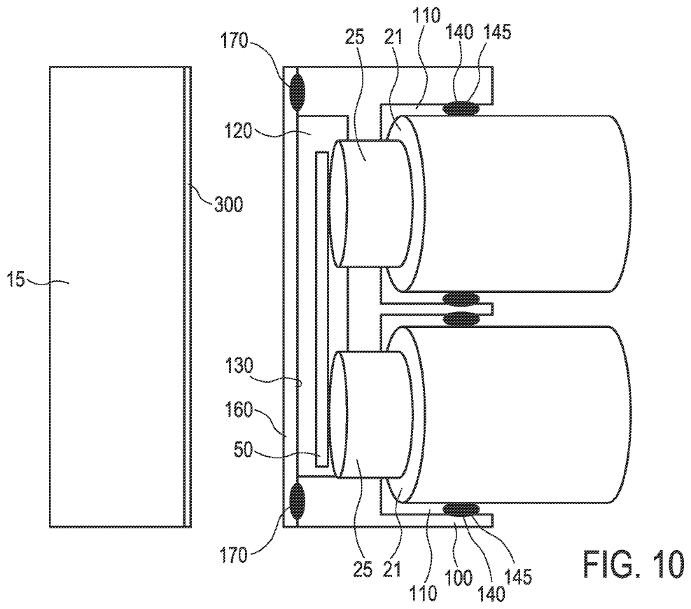

FIG. 10 shows an alternative design wherein, by contrast with the designs of FIGS. 8 and 9, the protective film 300 has been applied directly to the carrier 15. Here too, it may, for example, be applied by adhesive bonding or secured by means of a screw connection.

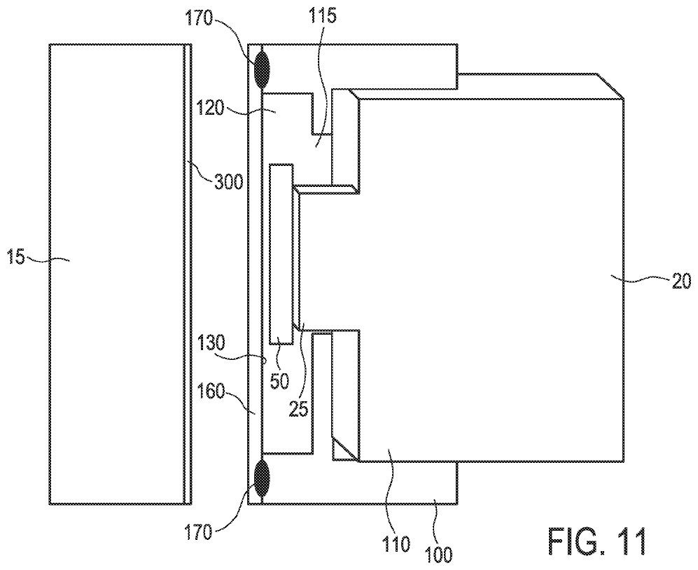

FIG. 11 shows a design that has been modified by comparison with FIG. 10 in that a prismatic cell 20 is used rather than round cells 20. In such a case too, the protective film 300 may advantageously be used to mitigate the effect of thermal events, although the other designs shown or described are possible in this case too.

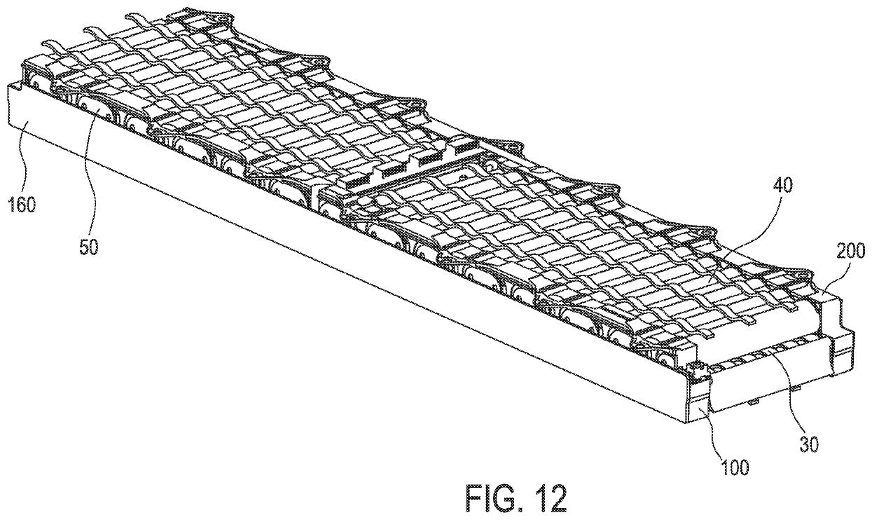

FIG. 12 shows an energy storage unit 10 in an alternative design. To some degree, this constitutes an installed state of the design of FIG. 1. With regard to the components that are not explicitly described hereinafter, reference is made to the description given further up.

In the design of FIG. 12, a cover element 160 mounted on the side of the first housing 100 does not, as in the case of other designs described so far, completely seal the chamber 120, but is open at the top. Thus, there is no achievement of a completely watertight design of the chamber 120. Instead, protection is achieved against penetrating water up to a fill level defined by the upper edge of the cover element 160. Such a design may, for example, enable better ventilation of the chamber 120 and simultaneously offer protection against water, which can escape from a cooling system, for example, up to an expected fill level.

By virtue of the described designs for sealing of chambers and/or use of protective films, it is possible to increase the safety of electrical energy storage units overall, and it is especially possible to improve resistance to escaping cooling fluid and/or thermal events.

For reasons of readability, by way of simplification, the expression “at least one” has sometimes been left out. If a feature of the technology disclosed here is described in the singular or indeterminately (for example the/a energy storage cell, the/a seal, etc.), the plural thereof shall also be disclosed as well (for example the at least one energy storage cell, the at least one seal, etc.).

The preceding description of the present invention serves merely for illustrative purposes and not for the purpose of restricting the invention. Within the scope of the invention, various alterations and modifications are possible, without leaving the scope of the invention and equivalents thereof.

### LIST OF REFERENCE NUMERALS

10 energy storage unit
15 carrier
20 energy storage cell
21 first longitudinal end
22 second longitudinal end
25 first cell terminal
26 second cell terminal
28 pressure relief opening
29 particle
30 cooling element
40 insulation elements
50 cell connector
60 control element
100 first housing
110 receiver
115 passage
120 chamber
130 opening
140 seal
145 groove
150 molding
152 mat
154 ring-shaped region
160 cover element
165 latching geometry
170 weld bead
180 recess
200 second housing
210 receiver
300 protective film

1.-24. (canceled)

25. An energy storage unit for storing electrical energy, comprising:
one or more energy storage cells;
one or more carriers; and
one or more protective films disposed between the one or more energy storage cells and the one or more carriers.

26. The energy storage unit according to claim 25, wherein the protective films are thermally stable up to at least 800° C.

27. The energy storage unit according to claim 25, wherein the carriers form an electrical ground of the energy storage unit.

28. The energy storage unit according to claim 25, wherein the one or more protective films is electrically insulating.

29. The energy storage unit according to claim 25, wherein the one or more protective films is electrically insulating.

30. The energy storage unit according to claim 25, wherein the one or more protective films comprises a carrier material and one or two layers applied to the carrier material.

31. The energy storage unit according to claim 30, wherein the one or two layers is formed from mica or true mica.

32. The energy storage unit according to claim 30, wherein the carrier material is formed from polyethylene.

33. The energy storage unit according to claim 25, wherein the one or more protective films has a thickness of at least 0.05 mm.

34. The energy storage unit according to claim 25, wherein the one or more protective films has a thickness of not more than 0.1 mm.

35. The energy storage unit according to claim 25, wherein one, some or all of the one or more protective films has been applied atop at least one of the carriers.

36. The energy storage unit according to claim 25, wherein the one or more carriers has been wholly or partly covered by the one or more protective films.

37. The energy storage unit according to claim 25, wherein one, some or all of the one or more protective films has been applied at a distance from the one or more carriers.

38. The energy storage unit according to claim 25, wherein the energy storage unit has one or more housings in which there are formed one or more chambers into which the energy storage cells partially extend.

39. The energy storage unit according to claim 38, wherein one, some or all of the one or more protective films has been applied to one or more of the housings.

40. The energy storage unit according to claim 38, wherein one, some or all of the one or more chambers has an opening sealed watertight by a cover element.

41. The energy storage unit according to claim 40, wherein one, some or all of the one or more cover elements is formed by a respective protective film.

42. The energy storage unit according to claim 40, wherein one, some or all of the one or more protective films has been applied atop at least one cover element in each case.

43. The energy storage unit according to claim 25, wherein one, some or all of the one or more energy storage cells has at least one pressure relief opening, and wherein a protective film is disposed between one, some or all of the at least one pressure relief opening and at least one of the one or more carriers.

44. The energy storage unit according to claim 25, wherein one, some or all of the one or more protective films completely covers a cross section between a carrier and one or more energy storage cells.

45. The energy storage unit according to claim 25, wherein the energy storage cells are designed as round cells and/or wherein longitudinal axes of the energy storage cells are aligned parallel to one another.

46. The energy storage unit according to claim 25, wherein the energy storage cells are designed as prismatic cells.

47. The energy storage unit according to claim 25, wherein the one or more carriers mechanically stabilize the energy storage unit.

48. A vehicle having an energy storage unit according to claim 25.
